(19) United States
(12) Patent Application Publication
(10) Pub. No.: US 2008/0308652 A1
(43) Pub. Date: Dec. 18, 2008

(54) Rejuvenator

(76) Inventors: Paul Phillip Taylor, Birmingham (GB); Gary Philip Doyle, Birmingham (GB)

Correspondence Address: PAUL PHILLIP TAYLOR, 30, MAYFIELD ROAD, STREETLY, BIRMINGHAM, WEST MIDLANDS, B74 3PY, GB

(21) Appl. No.: 11/818,923

(22) Filed: Jun. 18, 2007

(51) Int. Cl. B05B 7/24; A47K 3/28

(52) U.S. Cl. 239/302; 4/597

(57) ABSTRACT

The Rejuvenator adds the contents of a container of an admixture to the flow of shower water or bath and hand wash supplies for a specific application. The Rejuvenator 1 is attached to the outlet of a shower unit or mixer shower by screwing the female cone gland 2 onto that outlet. Then a shower hose can be attached to the male gland 3. The container of an admixture 6 (seen in FIG. 3) can be attached by screwing 7 into the rejuvenator 1, at 5. Turning the selector wheel 4 can regulate the amount of admixture used.

NB: The Rejuvenator will have to be fitted by a qualified plumber to the hand and bath water supplies and water supply for toilet cisterns. (For hand and bath water, Rejuvenator could be manufactured with mixer tap attached).

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

The Rejuvenator is an application tool that admixes a substance to shower water and other water supplies to assist with many different application scenarios.

The Rejuvenator is a device that adds a substance/additive to shower water for freshening up purposes and hygiene and medical purposes. The general public in households and all other establishments such as the workplace, hotels, leisure centres, and all who wish to use it can.

Another use for the Rejuvenator will be to render a substance admixed with shower water for animal houses or bath and hand wash supplies in hospitals, clinics and doctors' surgeries etc.

The Rejuvenator can be fitted to toilet cisterns to admix a substance to the cistern water for flushing.

### BRIEF SUMMARY OF THE INVENTION

This Rejuvenator has a container of a substance attached to it. It adds the contents of the container to the flow of shower water, bath and hand wash supplies and cistern water supplies.

A person has recently cleaned himself or herself in a shower and not long after decides to freshen up. Obviously, the need to clean is irrelevant because the person wants to just freshen up and feel revitalised and finish up fragrant.

The only way to finish up fragrant at the moment is to apply soap or shower gel. This can be deemed as a wasteful and futile exercise by having to apply the unnecessary soap or gel, when the need is, not to wash but to freshen up.

Furthermore, the Rejuvenator can admix a substance to shower water for the use in animal houses and bath and hand wash supplies for hospitals, clinics and the like.

When the rejuvenator is attached to a cistern it will have the advantage of metering in the desired amount of admixture that is required.

### BRIEF DESCRIPTION OF THE SEVERAL VIEWS OF THE DRAWING

Drawings of the rejuvenator and the bottle of admixture are shown on the following pages, which are on pages 9, 10 and 11.

FIG. 1 on page 9 shows a front view of the rejuvenator.

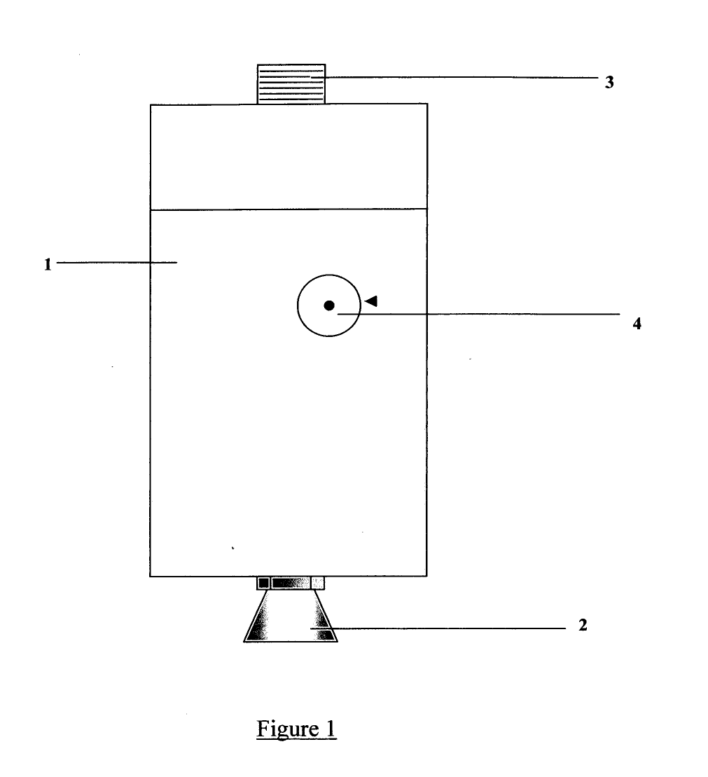

FIG. 2 on page 10 shows a side view of the rejuvenator.

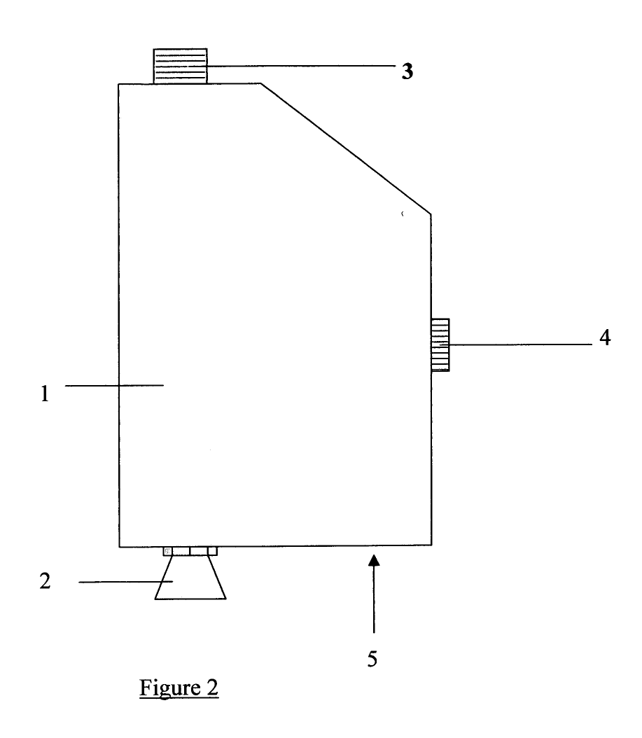

FIG. 3 on page 11 shows a view of the bottle that will hold the admixture.

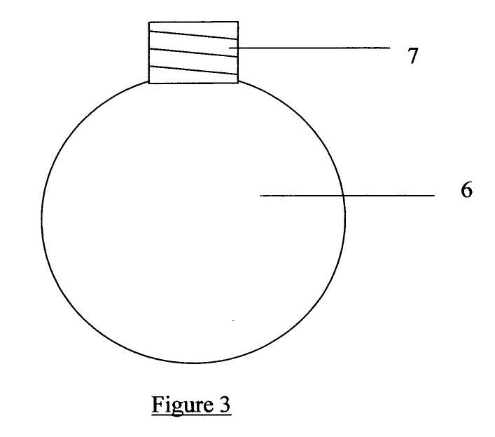

The rejuvenator 1 is attached to the outlet of a shower unit or mixer shower by screwing the female cone gland 2 onto that outlet. Then a shower hose can be attached to the male gland 3. The container admixture 6 can be attached to the rejuvenator 1 by screwing the threaded neck of the bottle 7 into the body of the rejuvenator 5. Once any user turns on his or her shower, the rejuvenator will introduce the admixture into the flow of shower water. Turning the selector wheel 4 to various different settings can regulate and meter the desired or required amount of admixture to the shower water and rendered out of the showerhead.

The shower is turned on resulting in the desired mixture rendered out of the showerhead to the user, to freshen up, revitalise and cleanse the user or another admixture with the water for a required application.

NB: The rejuvenator will have to be fitted by a qualified plumber to the hand and bath water supplies and water supply for toilet cisterns. (For hand and bath water, Rejuvenator could be manufactured with mixer tap attached).

### DETAILED DESCRIPTION OF THE INVENTION

Water flows through a venturi in the Rejuvenator and as it passes through, it induces the admixture and air into the water flow to render an atomised application of the mixture out of a showerhead, bath taps or hand wash taps.

The Rejuvenator can be attached to any shower unit or mixer shower or even built into the design of shower units or mixer showers. The contents of the bottle that is attached to the Rejuvenator will be injected into the flow of shower water. The device injects any admixture of the user's choice instantly to the flow of shower water thus rendering the desired application to the user.

The rejuvenator offers a solution for the user who wants to freshen up in his or her shower without having to apply soap or shower gel. The Rejuvenator renders a fragrant shower experience, thus the user is left feeling revitalised and fragrant. Moreover, this device offers the user a quick and instant fragrance to his or her shower when they need to just freshen up.

Consequently, the user does not have to apply soap or gel unnecessarily to attain a fragrance instead; a fragrance is rendered instantly out of the user's showerhead for freshening up purposes.

On the other hand, liquid soap can be admixed to shower water, hand and bath water supplies to ready mix for washing or bathing purposes, especially with elderly people making it easier for them to clean or for nurses or carers who have to wash elderly people or people of disability.

With this dispenser being able to add an admixture to bath and hand wash supplies, especially in hospitals and clinics, it would be a useful tool for hygienic purposes and the like. All patients, visitors and staff could wash hands with the an accurate amount of detergent mixed by the Rejuvenator, which would also be useful in clean rooms, laboratories and animal houses.

The Rejuvenator can help with the application of many admixtures to shower water or hand and bath water supplies used for medical purposes such as skin complaints where patients/consumers cannot apply in hard to reach places.

1. When the Rejuvenator is attached to any shower unit or mixer shower or built into any shower unit or mixer shower, a fragrance is added to the flow of shower water, which instantly renders a shower of fragrant water out of the showerhead to the user.

2. When the Rejuvenator is attached to any shower unit, mixer shower or built into any shower unit or mixer shower, a liquid soap can be added to the flow of shower water to ready mix for easier application for hard to reach places that any consumer experiences.

3. The Rejuvenator can be fitted to bath and hand wash supplies to add a soap to the water supply to ready mix for easier application for hard to reach places that any consumer experiences.

4. When the Rejuvenator is attached to any shower unit or mixer shower or built into any shower unit or mixer shower, a specific substance is added to the flow of shower water for a specific application.

5. The Rejuvenator can be fitted to showers and bath and hand wash supplies to add a specific substance to the water supply for hygienic and/or medical applications.

6. The Rejuvenator can be fitted to toilet cistern supplies to add a specific agent to the cistern water ready to use when flushing the toilet.

7. The rejuvenator can regulate and meter the amount of admixture added to the flow of water so a correct amount is rendered to the user.

8. Containers for the admixture can be screwed into the Rejuvenator for attachment, snapped into the Rejuvenator for attachment or manifolds can be built onto the Rejuvenator for high volume use (e.g. In leisure centres) and for multiple differing admixtures to be selected as desired by the user.
